(19) United States
(12) Patent Application Publication
(10) Pub. No.: US 2012/0265106 A1
(43) Pub. Date: Oct. 18, 2012

(54) System and Method for inducing Myofascial Release using Temperature Variation

(76) Inventors: David Michael Accardo, (US); Juan Herrera, (US)

(21) Appl. No.: 13/088,434

(22) Filed: Apr. 18, 2011

(51) Int. Cl. A61H 1/00; A61H 15/00

(52) U.S. Cl. 601/15; 601/123

(57) ABSTRACT

A system and method for inducing myofascial release using temperature variation. Specifically, myofascial release device can include a roller wherein said roller is hollow, and a temperature retention material inside the roller. The method can comprise heating or cooling the temperature retention material, and retaining the temperature retention material within said roller using said caps. Lastly, a method can include rolling the myofascial release device on a user, wherein the rolling causes myofascial release.

### BACKGROUND

Fascia is the soft tissue component of the connective tissue that provides support and protection for most structures within the human body, including muscle. This soft tissue can become restricted due to psychogenic disease, overuse, trauma, infectious agents, or inactivity, often resulting in pain, muscle tension, and corresponding diminished blood flow. Further, irritation of fascia or muscle can cause localized inflammation. Chronic inflammation can result in fibrosis, or thickening of the connective tissue, and this thickening causes pain and irritation, resulting in reflexive muscle tension that causes more inflammation. If untreated ischemia and somatic dysfunction can occur. Myofascial techniques can help myofascial release methods work by engaging the myofascial tissue restrictive barrier with a constant force until tissue release occurs or by gently stretching the tissue with only a few grams of pressure, allowing the fascia to unwind itself.

However the myofascial techniques can be painful and difficult as they require the tissue to release the barriers restricting movement and blood flow. One method to relax muscle tissues is by varying the temperature of the muscle. As such, it would be useful to have a system and method for inducing myofascial release using temperature variation.

### SUMMARY

A system and method for inducing myofascial release using temperature variation is described herein

In one embodiment, a myofascial release device can include a roller wherein said roller is hollow, further wherein said roller comprises a rolling edge, and a temperature retention material inside the said roller.

Additionally, a method for inducing myofascial release device is disclosed. The method can comprise heating or cooling said temperature retention material, and retaining said temperature retention material within said roller using said caps. Lastly the method can comprise rolling said myofascial release device on a user, wherein said rolling causes myofascial release.

### BRIEF DESCRIPTION OF THE DRAWINGS

FIG. 1 illustrates a perspective view of a myofascial release device on a user, wherein myofascial release device can be constructed of materials such as metal, carbon, wood and/or plastic.

FIG. 2 illustrates one embodiment of myofacscial release device wherein roller is capable of housing a temperature retention material.

FIG. 3 illustrates another embodiment of myofascial release device wherein myofascial release device can comprise roller, and temperature retention material.

FIG. 4a illustrates another embodiment of myofascial release device comprising a single ball.

FIG. 4b illustrates myofascial release device wherein it comprises multiple balls.

FIG. 4c illustrates another embodiment of myofascial release device essentially in the shape of a sphere.

### DETAILED DESCRIPTION

Described herein is a system and method for inducing myofascial release using temperature variation. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

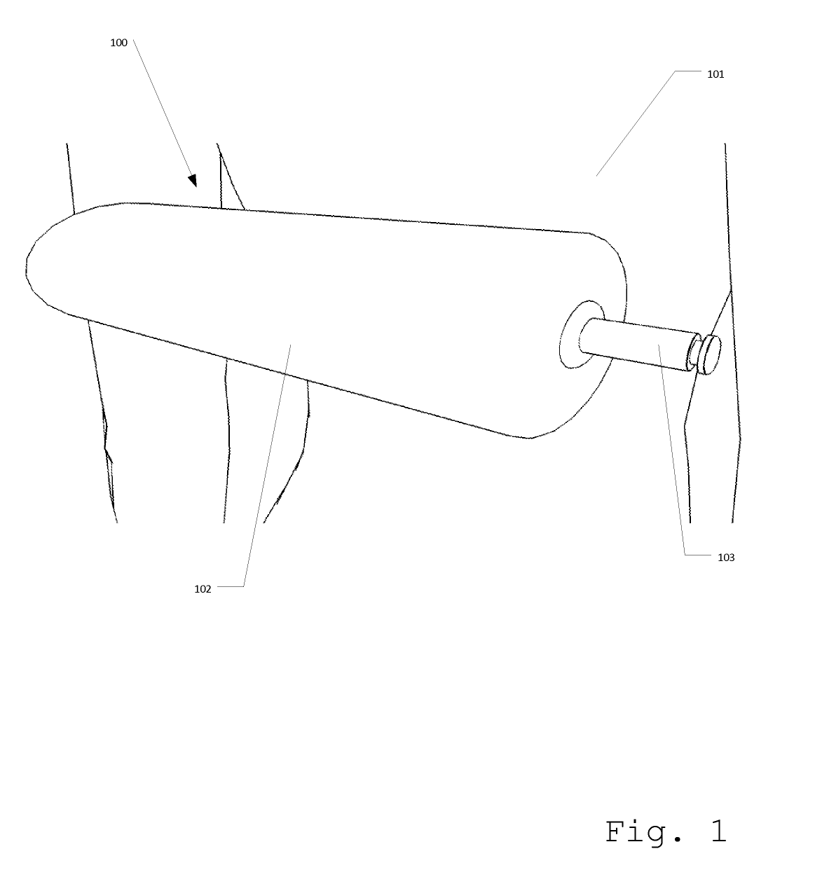

FIG. 1 illustrates a perspective view of a myofascial release device 100 on a user 101, wherein myofascial release device 100 can be constructed of materials such as metal, carbon, wood and/or plastic. In one embodiment, myofascial release device 100 can include a roller 102, and one or more handles 103. Roller 102 can be hollow. Myofascial release device 100 can vary in size, depending on among other considerations, which portion of the human body its use is intended. In one embodiment, handles 103 can be an ergonomic form in such a way user 101 can grab myofascial release device 100 easily. With an ergonomic form handles, user 101 or an aid to a user can easily apply pressure on roller 102 while performing a myofascial release session.

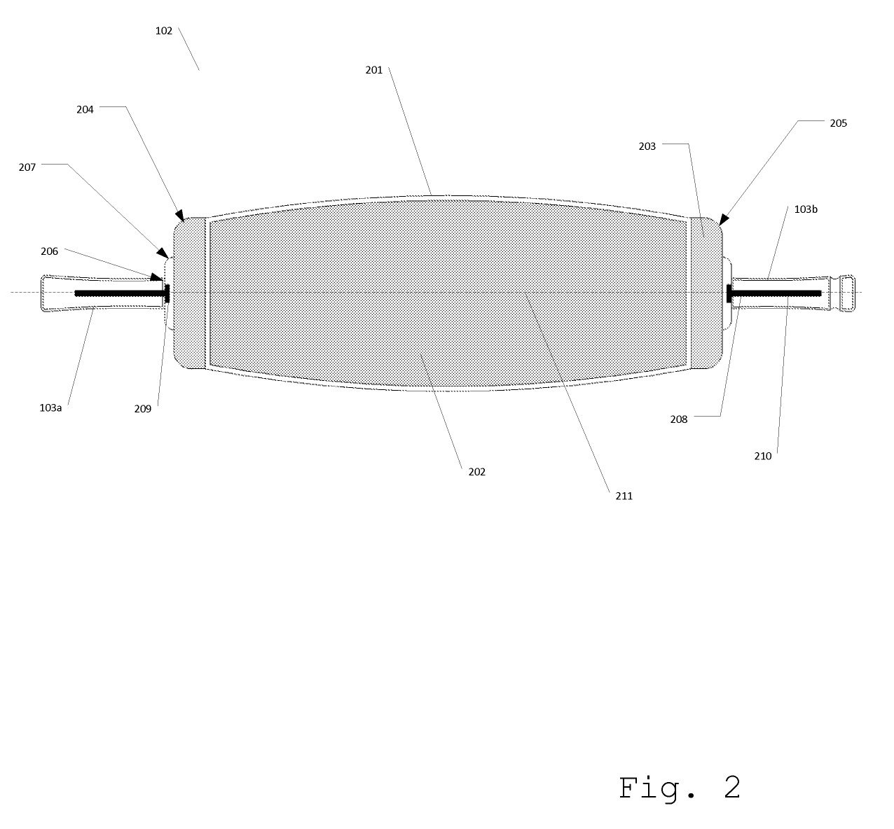

FIG. 2 illustrates one embodiment of myofacscial release device 100 wherein roller 102 is capable of housing a temperature retention material 202. Temperature retention material 202 can include, but is not limited to, liquids such as water, oil, or gel; and solids such as rice, beans, plastic pellets, metal pellets and/or rocks. The temperature retention material 202 can be placed directly into roller 102, or can be housed within in a separate container before being placed into roller 102. One example of such embodiment is a heating or cooling pack filled with gel, wherein the heating or cooling pack is insertable into roller 102. Before placing temperature retention material 202 into roller 102, user can heat or cool temperature retention material 202.

In one embodiment, roller 102 can comprise a one or more caps 203. Caps 203 can be used to prevent temperature retention material 202 from coming out of roller 102. An example of cap 203 can be a screw cap. In one embodiment, handles 103 can comprise a left handle 103a, and a right handle 103b placed on an axis that can be extended to the center of myofascial release device 100. Further in such embodiment, handles 103 can be affixed to a left side 204 and a right side 205 of myofascial release device 100. One means of affixing handles 103 can be a fastener placed on an inside portion 206 of handles 103 to an outside portion 207 of myofascial release device 100. For the purpose of this disclosure, fastener can be but not limited to a bolt, a screw, and/or a rivet. Another way of affixing handles 103 is using a rotary element unit 208 that can be inserted into portion 206 of handles 103. Rotary element unit 208 can includes a rolling element bearing 209, and/or a shaft 210. In addition, rotary element bearing 209 can provide a rolling motion when myofascial release device 100 is rubbed onto a localized part of user 101. In another embodiment, rotary element unit 208 can be a built-in component inside handles 103. In one embodiment, roller 102 can be cylindrical. In such embodiment, roller 102 has a flat rolling edge. In another embodiment, roller 102 can vary in width along the axis. In such embodiment, roller 102 can have a curved or otherwise inconsistent rolling edge

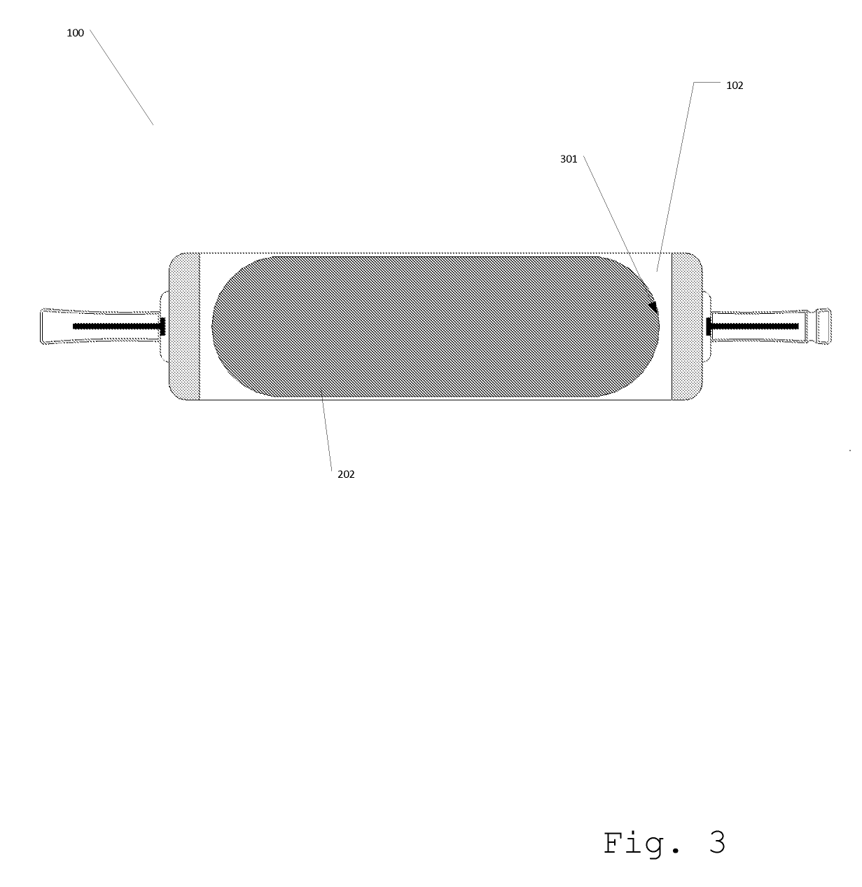

FIG. 3 illustrates another embodiment of myofascial release device 100 wherein myofascial release device 100 comprising roller 102 with a flat rolling edge. In one embodiment, myofascial device 100 can comprise an aperture 301 that gives access to the inside of roller 102. By sealing aperture 301, temperature retention material 202 is trapped within roller 102. In one embodiment, aperture 301 can be plugged by cap 203. In such embodiment, said cap 203 can comprise handle 103.

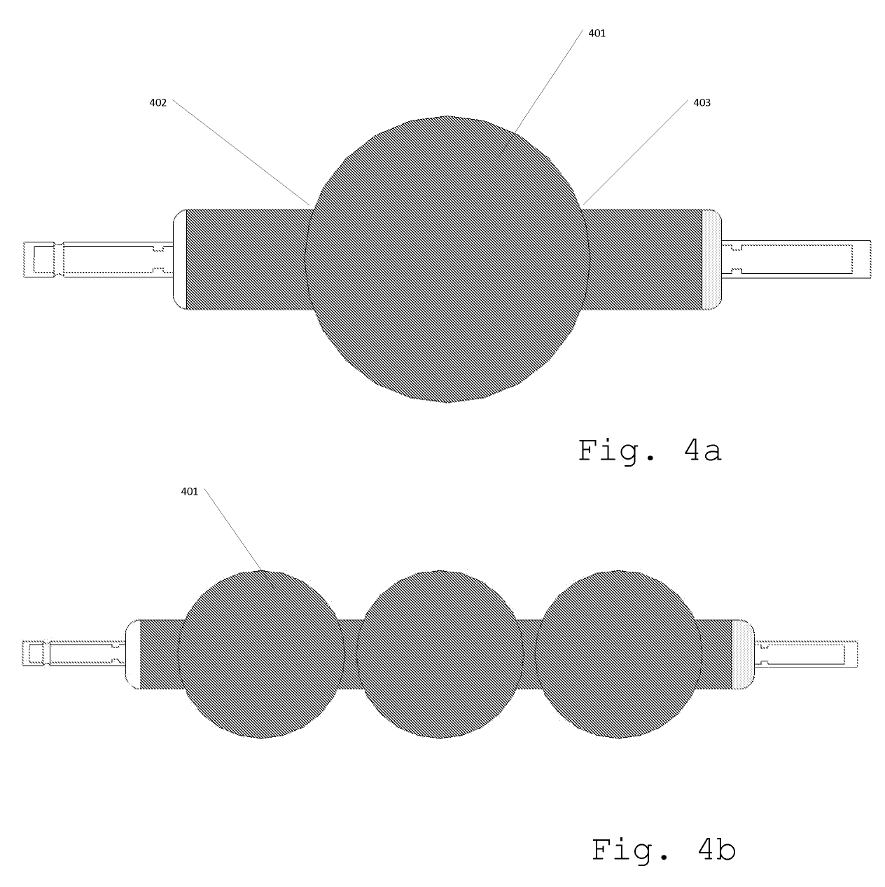

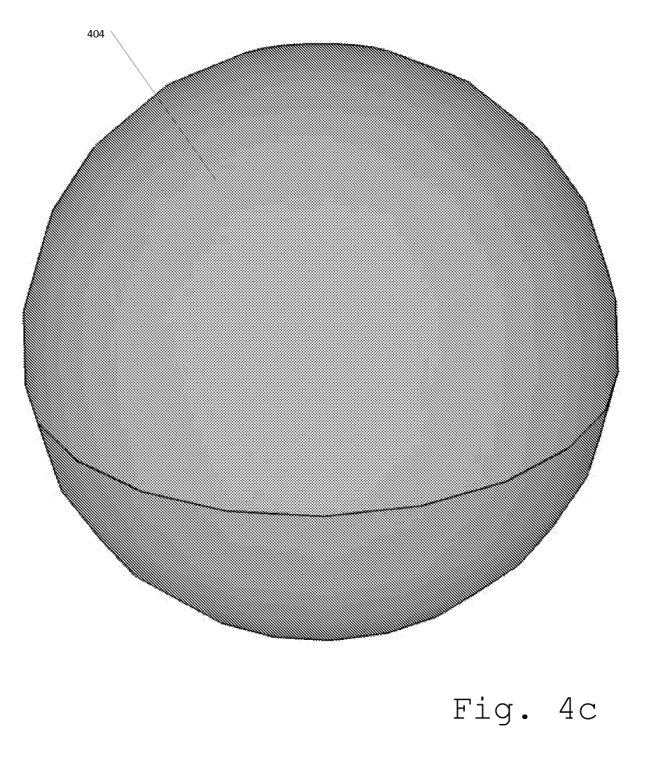

FIGS. 4 illustrate various embodiments of myofascial release device 100. FIG. 4a illustrates another embodiment of myofascial release device 100 comprising a single ball 401. In one embodiment, ball 401 can further include roller 102 passing through ball 401 at a left junction 402 and a right junction 403. FIG. 4b illustrates myofascial release device 100 wherein it comprises multiple balls 401. In one embodiment, the size of balls 401 can vary according to the size of a user and the part of the body for which it is intended to be used. One of the benefits of having a ball shaped myofascial release device is narrowing the contact area between roller 102 and a user, allowing for greater pressure. FIG. 4c illustrates another embodiment of myofascial release device 100 essentially in the shape of a sphere 404. One benefit of a spherical myofascial release device 100 is the ability to roll the device in multiple directions.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A myofascial release device comprising
a roller, wherein said roller is hollow, further wherein said roller comprises a rolling edge and;
a temperature retention material inside said roller;

2. The myofascial release device of claim 1 wherein said roller comprises a sphere.

3. The myofascial release device of claim 1 wherein said roller comprises a plurality of spheres.

4. The myofascial release device of claim 1 further comprising
a first handle connected to a left side of said roller, wherein said first handle is placed on an axis extending through a center of said roller, and
a second handle connected to a right side of said roller wherein said second handle is placed on said axis extending through said center of said roller.

5. The myofascial release device of claim 1 wherein said rolling edge is curved.

6. The myofascial release device of claim 1 wherein said rolling edge is straight.

7. The myofascial release device of claim 3 wherein said roller comprises a removable cap.

8. The myofascial release device of claim 3 wherein said left handle connects to said cap.

9. The myofascial release device of claim 1 wherein said temperature retention material is enclosed in a container.

10. The myofascial release device of claim 1 wherein said temperature retention material and said container is an ice pack.

11. The myofascial release device of claim 1 wherein said temperature retention material and said container is a heating pack.

12. The myofascial release device of claim 1 wherein said temperature retention material is rice.

13. The myofascial release device of claim 1 wherein said temperature retention material is water.

14. The myofascial release device of claim 1 wherein said temperature retention material is gel.

15. The myofascial release device of claim 1 wherein said temperature retention material is oil.

16. The myofascial release device of claim 1 wherein said temperature retention material is rocks.

17. The myofascial release device of claim 1 wherein said temperature retention material is metal pellets.

18. A method for inducing myofascial release device comprising
varying a temperature of a temperature retention material, and;
retaining said temperature retention material within a myofascial release device wherein said myofascial release device comprises a roller for storing said temperature retention material;
rolling said myofascial release device on a user, wherein said rolling causes myofascial release.
